(19) United States
(12) Patent Application Publication
(10) Pub. No.: US 2010/0245005 A1
(43) Pub. Date: Sep. 30, 2010

(54) SUPERCONDUCTING WIRE ROD, PERSISTENT CURRENT SWITCH, AND SUPERCONDUCTING MAGNET

(75) Inventors: Masaya TAKAHASHI, Hitachinaka (JP); Michiya OKADA, Mito (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/697,609

(22) Filed: Feb. 1, 2010

(30) Foreign Application Priority Data
Mar. 31, 2009 (JP) 2009-083991

(51) Int. Cl. H01F 6/00; H01B 12/00

(52) U.S. Cl. 335/216; 174/125.1

(57) ABSTRACT

The present invention provides a superconducting wire usable in a low magnetic field region of 2 T or lower and at a temperature of 4.2 K or lower and a connection structure and a connection method for permitting such a superconducting wire use. The present invention also provides a highly reliable device that uses a superconducting wire. A superconducting wire rod according to an embodiment of the present invention includes a plurality of superconducting metal filaments, which are embedded in a metallic matrix of a normal conductor. Each superconducting metal filament is provided with a barrier layer made of a metal that does not react with Sn at a temperature between 250° C. and 500° C. The barrier layer is preferably made of Ta, Mo, or Ta- or Mo-based alloy and 0.01 μm to 1 μm in thickness.

### BACKGROUND OF THE INVENTION

1. Field of the Invention

The present invention relates to a persistent current switch that switches between a normal-conducting state and a superconducting state in a superconducting magnet circuit or other circuit in need of a persistent current operation. The present invention also relates to a connection of a superconducting wire rod and a connection method thereof.

2. Description of the Related Art

A superconducting magnet, which requires a persistent current operation, is used, for instance, in a nuclear magnetic resonance analysis system, a medical magnetic resonance imaging system, a magnetically levitated train, a superconducting power storage facility, a magnetic separation apparatus, an in-magnetic-field single crystal pull-up apparatus, a refrigerator cooled superconducting magnet apparatus, a superconducting energy storage, a superconducting generator, and a fusion reactor magnet system. A persistent current switch is used to switch between the normal-conducting state and superconducting state of the superconducting magnet.

A superconducting wire for the persistent current switch is made of a multi-core superconducting wire rod that includes a plurality of thin superconducting metal filaments and a metallic matrix for stabilizing and integrating the filaments. A NbTi superconducting wire rod is most widely used as a superconducting metal filament. In general, the NbTi superconducting wire rod is manufactured by performing hot extrusion with a number of NbTi alloy filaments embedded in a matrix of copper or other metal for stabilization and repeating an aging heat treatment and a wire-drawing process. However, Cu in the metallic matrix may react with Ti in the NbTi alloy to generate a CuTi compound during the hot extrusion process or aging heat treatment. The CuTi compound can be a major cause of wire breakage during the wire-drawing process due to its poor machinability. Therefore, a barrier material that does not react with Ti or Cu and exhibits excellent wire-drawing processability should be placed between the metallic matrix and NbTi alloy filament to produce effective results. JP-A-9-223425 has disclosed that Nb, for example, can be used as a barrier material.

### SUMMARY OF THE INVENTION

In a superconducting magnet used in a magnetic field of 5 T or higher, Nb exhibits a normal-conducting state. Within liquid helium at a temperature of 4.2 K, however, the persistent current switch is generally installed in a region of 2 T or lower. Particularly, a connection between the persistent current switch and the superconducting magnet is often installed in a region of 1 T or lower. If the magnetic field strength is 1 T or lower in a situation where Nb is used as a barrier material, the barrier layer itself may enter a superconducting state.

If Nb enters a superconducting state in a magnetic atmosphere where the persistent current switch is installed, the superconducting metal filaments couple with each other within the persistent current switch so that superconductor quenching is likely to occur. Within a superconducting connection, in particular, the metallic matrix of a wire rod is removed; therefore, the superconducting metal filaments come to closer to each other than in a wire rod state. This increases the probability of coupling-induced superconductor quenching.

An object of the present invention is to provide a superconducting wire usable in a low magnetic field region of 2 T or lower and at a temperature of 4.2 K or lower and a connection structure and a connection method for permitting such a superconducting wire use. Another object of the present invention is to provide a highly reliable device that uses a superconducting wire.

In accomplishing the above objects, according to an embodiment of the present invention, there is provided a superconducting wire rod including a plurality of superconducting metal filaments. The superconducting metal filaments are embedded in a metallic matrix of a normal conductor. Each superconducting metal filament is provided with a barrier layer made of a metal that does not react with Sn at a temperature between 250° C. and 500° C. If the barrier layer does not enter a superconducting state at 4.2 K or lower and at 0.5 T or lower, the superconducting wire rod can also be used in a low magnetic field region. It is particularly preferred that the superconducting metal filaments be made of NbTi, and that the metallic matrix of a normal conductor be made of copper or a copper-based alloy such as a Cu—Ni alloy, and further that the barrier layer be made of Ta, Mo or Ta- or Mo-based alloy, such as NbTa, TaMo.

A superconducting wire rod connection method according to another embodiment of the present invention is to substitute at least a part of the metallic matrix of the superconducting wire rod by tin or a tin alloy, substitute the substituted tin or tin alloy by a superconducting alloy having a low melting point, particularly by lead or a lead alloy such as Pb—Bi, and connect a plurality of superconducting wire rods with the substituted superconducting alloy. The use of this method inhibits the metallic matrix of an unsubstituted normal conductor from staying. This makes it possible to form an excellent superconducting connection.

A superconducting wire rod connection structure according to another embodiment of the present invention ensures that the metallic matrix of a normal conductor is removed from at least a part of a superconducting wire rod, and that a plurality of superconducting metal filaments having a barrier layer are integrated via a low melting point superconducting alloy.

A device according to still another embodiment of the present invention uses a superconducting wire having the above-mentioned connection. This apparatus not only includes the above-mentioned connection, but is configured so that a portion other than the connection of the superconducting wire is covered with the metallic matrix of a normal conductor. The use of this configuration makes it possible to provide a persistent current switch that is not likely to become defective or quenched even when it is used in a low magnetic field region of 2 T or lower and at a temperature of 4.2 K or lower.

The use of the above-described configuration also makes it possible to provide a device that can implement a highly reliable persistent current circuit. For example, the device may be a superconducting magnet that is used, for instance, in a nuclear magnetic resonance analysis system, a medical magnetic resonance imaging system, a magnetically levitated train, a superconducting power storage facility, a magnetic separation apparatus, an in-magnetic-field single crystal pull-up apparatus, a refrigerator cooled superconducting magnet apparatus, a superconducting energy storage, a superconducting generator, and a fusion reactor magnet system.

The present invention is also applicable to a superconducting current limiting device, a disturbance attenuation coil, and other devices in which the connection performance of a superconducting wire rod is essential.

As described above, the present invention makes it possible to provide a device in which a highly reliable superconducting circuit is mounted.

### BRIEF DESCRIPTION OF THE DRAWINGS

Other objects and advantages of the invention will become apparent from the following description of embodiments with reference to the accompanying drawings in which:

FIG. 1 is a diagram illustrating a closed circuit for a persistent current operation;

FIG. 2 is a cross-sectional view illustrating the configuration of a wire rod for a persistent current switch;

FIG. 3 is a cross-sectional view illustrating an exemplary configuration of a superconducting connection;

FIG. 4 is a diagram illustrating an example of a persistent current switch;

FIGS. 5A and 5B are cross-sectional views illustrating a superconducting wire rod whose matrix is substituted by Sn;

FIG. 6 is a diagram illustrating a closed circuit for a persistent current operation according to an embodiment of the present invention;

FIG. 7 is a diagram illustrating the result of a test performed in accordance with a second embodiment of the present invention;

FIG. 8 is a diagram illustrating the result of a test performed in accordance with a third embodiment of the present invention; and

FIG. 9 is a diagram illustrating an exemplary configuration of a superconducting magnet.

### DESCRIPTION OF THE PREFERRED EMBODIMENTS

The present invention will now be described in detail.

The wire rod according to the present invention is a multi-core superconducting wire rod that is configured by embedding a plurality of superconducting metal filaments covered with a barrier layer in the matrix of a normal conductor. In a certain case where a persistent current operation was previously performed with a superconducting magnet made of a compound-based superconducting wire, a persistent current switch composed of a NbTi superconducting wire that used a CuNi alloy as a stabilizing material was used.

It is assumed that the wire rod according to the present invention is to be used primarily for a persistent current switch. In such an instance, the wire rod is used in a low magnetic field region of 2 T or lower and at a temperature of 4.2 K or lower. It is also assumed that a connection of the wire rod, in particular, is for use in a low magnetic field region of 1 T or lower. Therefore, it is necessary that the barrier layer be not superconductive in a low magnetic field region of 2 T or lower and at a temperature of 4.2 K or lower. The use of such a barrier layer makes it possible to suppress coupling between the superconducting metal filaments, thereby suppressing superconductor quenching which is caused by the connection. The superconducting metal filaments can be made of NbTi, MgB₂, Nb₃Sn, Nb₃Al, or other superconducting material.

It is preferred that the barrier layer be made of Ta, Mo, or a Ta- or Mo-based alloy and 0.01 μm to 1 μm in thickness. As the problem of connection quenching is not limited to multi-core superconducting wire rods, the present invention can also be applied to single-core superconducting wire rods.

Persistent current circuit quenching frequently occurs particularly at a superconducting wire connection. When a plurality of superconducting wires are to be connected, the metallic matrix covering the filaments may be substituted by Pb, Pb—Sn, or other superconductor having a low melting point. The inventors of the present invention have discovered that the performance of the connection is degraded, for instance, by the metallic matrix remaining within the connection at the time of substitution. When Sn is used to solid-solve or dissolve the metallic matrix, Nb reacts with Sn to form NbSn₂ and Nb₆Sn₅, which are normal-conducting. It is found that the yield rate of a product having a sound superconducting connection is low because solid solution and dissolution of the metallic matrix is obstructed.

When a solid solution/diffusion reaction with Sn is to be used during a connection process, it is necessary that the barrier layer installed between superconducting metal filaments and normal-conducting matrix refrain from reacting with Sn at a temperature between 250° C. and 500° C. When the above configuration is employed, the metallic matrix of the connection can be sufficiently substituted. This makes it possible to suppress superconductor quenching which is caused by a defective connection.

Effective results will be produced when Ta, Mo, or a Ta- or Mo-based alloy is used as a metal that does not react with Sn at a temperature between 300° C. and 500° C. and does not enter a superconducting state in a low magnetic field region of 2 T or lower and at a temperature of 4.2 K or lower. The superconducting metal filaments according to the present invention may be made of a NbTi wire or other superconductor. An alloy-based superconductor and a compound-based superconductor are well-known as a superconductor. The aforementioned problem with the connection is also common to the superconducting connection of a wire other than a NbTi wire. It is preferred that the metallic matrix of a normal conductor be made of a Cu-based alloy such as CuNi, CuSn, CuZn, CuMn, CuMg, CuIn, CuCo, and CuCr.

When the superconducting metal wire structure and superconducting wire connection method for forming an appropriate connection are identified as described above, it is possible to provide a highly reliable persistent current switch and a superconducting magnet or like device having a persistent current circuit.

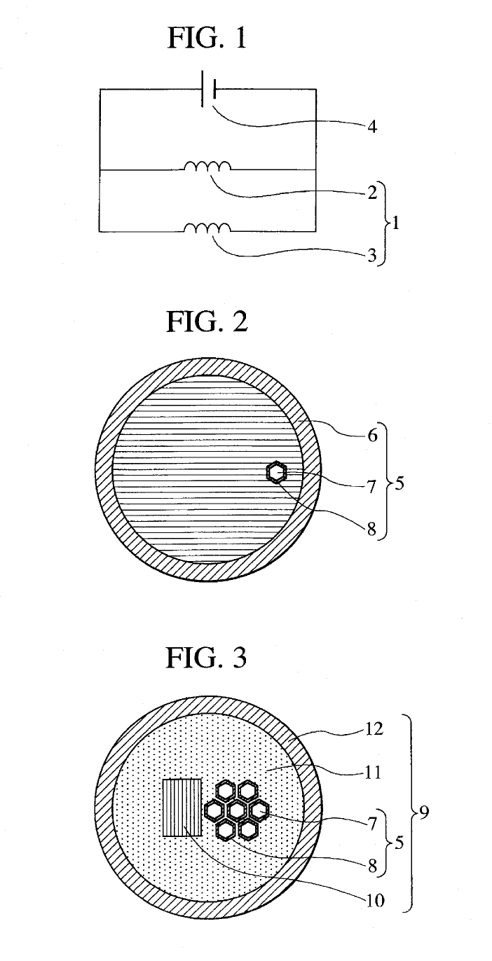

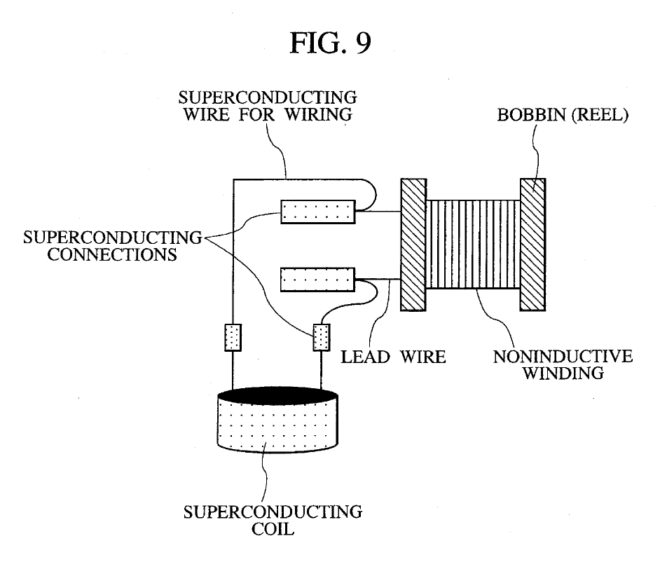

The superconducting magnet is operated by either of two different methods. A first method is to cause a current to flow from a power supply to a superconducting coil at all times. A second method is to connect the persistent current switch and superconducting coil in parallel to a power supply within a circuit similar to the one shown in FIG. 1, excite the superconducting coil, and switch to a persistent current operation by allowing the persistent current switch to disconnect the superconducting coil from the power supply. In a nuclear magnetic resonance analysis system (hereinafter referred to as an NMR system), a medical magnetic resonance imaging system (hereinafter referred to as an MRI system), a magnetically levitated train, and the like, the superconducting magnet is operated mostly by performing a persistent current operation by the latter method. FIG. 9 is a schematic diagram illustrating the superconducting magnet.

A persistent current operation performed with the persistent current switch will now be described with reference to FIG. 1. The superconducting magnet 1 that performs a persistent current operation includes a superconducting coil 2 and a short-circuiting switch 3, which is positioned between terminals of the superconducting coil 2. The short-circuiting switch 3 is called a persistent current switch and formed with a superconducting wire to lower the resistance prevailing at the time of short circuiting.

A sequence of a persistent current operation will now be described. First of all, the superconducting wire is placed in a normal-conducting state (hereinafter referred to as the PCS-OFF state) to generate high resistance by heating or exciting a heater or otherwise invoking external disturbance until the critical temperature and critical magnetic field of the superconducting wire forming the persistent current switch 3 are exceeded. To excite the superconducting coil 2, a power supply 4 then supplies electrical power to the superconducting coil 2 until a rated current value is reached. Next, the external disturbance, which has placed the persistent current switch 3 in a normal-conducting state, is stopped to place the persistent current switch 3 in a superconducting state (hereinafter referred to as the PCS-ON state). This decreases the current value of the power supply. As a result, a persistent current operation can be performed between the superconducting coil 2 and persistent current switch 3.

To properly perform the above-described persistent current operation, it is necessary to ensure that the resistance of the persistent current switch is extremely low (practically zero) in the PCS-ON state and high in the PCS-OFF state. It is also necessary to steadily supply a rated current for a long period of time in the PCS-ON state and assure stability by avoiding an unnecessary switch to a normal-conducting state.

To meet the above characteristics requirements, the superconducting wire for the persistent current switch uses a number of extremely thin filaments to form a multi-core structure. In addition, the length of a wire rod is increased.

Further, a superconductor is used for persistent current switch connection. For example, a superconductor is used to connect the persistent current switch to the superconducting coil or other superconducting circuit. Furthermore, a superconducting connection is formed to have a stable structure.

Previously, the use of a NbTi wire that uses a CuNi alloy as a stabilizing material and has high conductivity was preferred, and Nb was used as a barrier material. This type of persistent current switch is generally used in liquid helium at a temperature of 4.2 K. However, the critical temperature of NbTi is approximately 9 K so that the temperature margin between an operating temperature and critical temperature is as small as approximately 5 K. Therefore, even when small disturbance energy enters, the superconducting wire is easily heated above the critical temperature. As a result, a switch to a normal-conducting state is likely to take place. There is a problem with a persistent current switch that uses a NbTi wire. Such a persistent current switch readily switches to a normal-conducting state due to a small temperature margin. Therefore, when a NbTi wire having a low critical temperature is used as a persistent current switch superconducting wire, there is no alternative but to use the NbTi wire under more severe conditions.

Further, a CuNi alloy exhibiting more than ten times the electrical high-value resistance of normal oxygen-free copper is used as a stabilizing material for the persistent current switch NbTi wire. Such a CuNi alloy is used in order to expedite the excitation of the superconducting coil and increase the electrical high-value resistance of the persistent current switch. However, this metallic matrix also increases the likelihood that the persistent current switch will switch to a normal-conducting state.

Furthermore, the thin multi-core structure of the superconducting metal filaments, which is employed to suppress superconductor quenching, decreases the stability of the superconducting connection.

It is preferred that the persistent current switch to be used be installed in a low magnetic field environment (a low magnetic field of 2 T or lower) with a relatively low rated current setting employed. Its superconducting connection is then also installed in a low magnetic field of 1 T or lower. This makes it necessary to design a low magnetic field wire rod in a manner different from the manner in which a superconducting wire rod for an ordinary superconducting coil is designed. Consequently, it is necessary to ensure that coupling between superconducting metal filaments does not occur in a low magnetic field region of 2 T or lower in the case of a superconducting wire forming the persistent current switch and in a low magnetic field region of 1 T or lower in the case of a superconducting wire forming the connection.

Moreover, when a process of using Sn during the solid solution/diffusion of CuNi for the connection of a superconducting wire is to be performed, it is also necessary to ensure that the barrier layer does not react with Sn.

FIG. 2 is a cross-sectional view illustrating the structure of a superconducting wire for the persistent current switch. A wire rod 5 includes a plurality of superconducting metal filaments 7 and a normal-conducting metallic matrix 6 for stabilizing the filaments. Each filament is provided with a barrier layer 8. It is preferred that the barrier layer be 0.01 μm to 1 μm in thickness and made of Ta or Mo, or Ta- or Mo-based alloy. Ta and Mo are in a normal-conducting state when the temperature is 4.2 K and the magnetic field strength is 0.5 T. Therefore, the superconducting metal filaments do not couple within the superconducting wire rod. Further, even if Sn is used to manufacture the connection, Ta and Mo do not form an alloy layer with Sn at a temperature between 250° C. and 500° C. Therefore, the reaction between Sn and barrier layer is suppressed so that CuNi of a wire rod metallic matrix can be solid-solved and diffused in a sound manner.

It is preferred that the metallic matrix 6, which is highly resistive, be made, for instance, of CuNi, CuSn, CuZn, CuMn, CuMg, CuIn, CuCo, or CuCr. A Cu-based alloy can produce an adequate cooling effect while exhibiting high resistance. An alloy based, for instance, on Al, Ag, Au, or Pt can also be used because it produces a high cooling effect. In terms of resistance, cooling effect, and price, however, the use of a Cu alloy is preferred. Particularly if commercialization is intended, the use of a CuNi alloy or CuSn alloy is preferred.

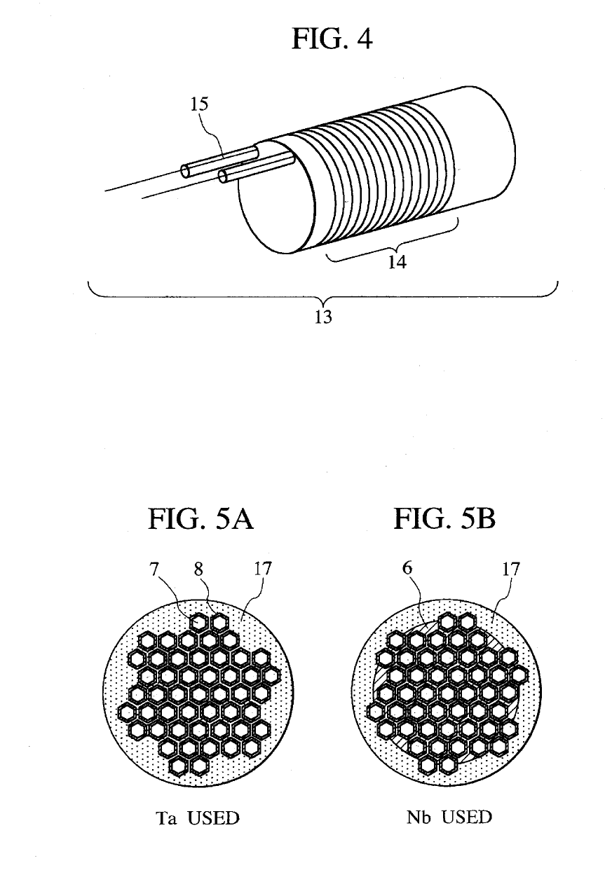

FIG. 4 is a diagram illustrating an example of the persistent current switch 3. The persistent current switch 3 is cylindrically shaped and uses a bobbin 13 having a lead wire retainer 15. The bobbin 13 around which a superconducting wire rod is wound can be made, for instance, of stainless steel, FRP, or ceramics. In the example shown in FIG. 4, the aforementioned superconducting wire rod and a heater wire for switching between superconducting and normal-conducting states are wound around a cylindrical portion of the bobbin in a noninductive or solenoidal manner, and the resulting winding 14 is resin-impregnated. An end of a wire rod is fastened to the lead wire retainer 15. There is a superconducting connection 9 at the leading end of a lead wire.

To increase the high-value resistance of the persistent current switch, it is preferred that the employed wire rod be sufficiently long. Further, it is preferred that the wire rod be wound around the bobbin in a noninductive manner to reduce the inductance of the persistent current switch. If the superconducting coil to be excited or the current value is small, an ordinary solenoid winding configuration may be employed instead of a noninductive winding configuration.

Impregnating the winding with resin not only secures the superconducting wire rod and heater wire but also prevents insulation and breakage. The winding can be impregnated with epoxy resin, wax, beeswax, or the like.

It is preferred that a lead of the persistent current switch be provided with a lead groove into which the lead wire is to be wound. The reason is that a Cu wire is used as a collinear wire, soldered to the NbTi wire, and wound together in order to increase the stability of the NbTi wire.

FIG. 3 is a cross-sectional view illustrating an example of the superconducting connection 9 between the persistent current switch and other superconductor. The superconducting metal filaments 7 in the persistent current switch wire rod 5 and a superconducting portion 10 of the superconducting wire to be connected are placed in a connecting tube 12, and the gap between the superconducting metal filaments 7 and the superconducting portion 10 is filled with a superconductor 11 made of a metal or alloy having a low melting point. This establishes a structure in which the superconductor 11 in the connecting tube 12 connects the persistent current switch to the other superconductors.

As the superconductor 11 made of a metal or alloy having a low melting point, a metal or alloy that exhibits low-melting-point superconductivity, has a melting point of 400° C. or lower, and is superconductive at a temperature of 4.2 K can be used. If the persistent current switch is to be used in a so-called superfluid state at a temperature of 4.2 K or lower, a superconductor that enters a superconducting state at a temperature higher than 4.2 K can be used. It is preferred that Sn, Mg, In, Ga, Pb, Te, Tl, Zn, Bi, Al, or other similar metal or an alloy made of two or more of these metals be used. It is highly preferred that a PbBi alloy or PbBiSn alloy be used because they are highly superconductive.

The superconducting portion 9, which is to be connected as described with reference to FIG. 3, may be a multi-core wire similar to the persistent current switch wire rod shown in FIG. 2. FIGS. 5A and 5B are schematic diagrams illustrating two exemplary multi-core wires in which a metallic matrix is substituted by Sn. To ensure that the superconducting connection is stable and sound, it is necessary to solid-solve and diffuse the entire normal-conducting matrix. A multi-core wire rod obtained by integrating a number of superconducting metal filaments having a barrier layer with a CuNi metallic matrix was prepared. One type had a barrier layer made of Ta or Mo. Another type had a barrier layer made of Nb. Two pieces of each type were prepared. When persistent current switch wire rods having a barrier layer made of Ta or Mo were connected in an experiment for substituting CuNi by Sn, the normal-conducting metallic matrix 6 was entirely substituted by Sn 16. When, on the other hand, persistent current switch wire rods having a barrier layer made of Nb were connected in an experiment, the center of the normal-conducting metallic matrix 6 largely remained. In the resulting state, the superconducting metal filaments in a portion in which the normal-conducting metallic matrix remained were left unconnected. Thus, the number of filaments through which a current flowed was decreased to destabilize the superconducting connection.

Therefore, when the persistent current switch is manufactured with a superconducting wire rod having a barrier layer made of Ta or Mo as described in conjunction with the present invention, it is possible to (1) reduce the resistance to zero in the PCS-ON state and assure stability, (2) exhibit high resistance in the PCS-OFF state, (3) supply a rated current steadily for a long period of time, and (4) provide a persistent current switch that does not switch to a normal-conducting state unless it is necessary. This persistent current switch produces effective results when it is used with a superconducting magnet for an MRI system, an NMR system, a magnetically levitated train, or other equipment that requires a persistent current operation. When a superconducting magnet system performing a persistent current operation is established, it is possible to conduct a thermally stable persistent current operation. This persistent current switch also produces effective results when it is used with a superconducting current limiting device or a disturbance attenuation coil.

Embodiments of the present invention will now be described as concrete examples.

### First Embodiment

A first embodiment of the present invention will be described below by explaining about the manufacturing process of a prototype model of the persistent current switch.

As a superconducting wire for the persistent current switch, a superconducting wire (multi-core wire having a triplex structure of CuNi—Ta—NbTi) including a normal-conducting matrix made of a Cu-10 wt % Ni alloy, a barrier layer made of Ta, and a plurality of NbTi superconducting metal filaments was used. Meanwhile a NbTi wire was used as the other superconducting wire to be connected. The persistent current switch was manufactured by using a PbBiSn alloy as a low-melting-point superconducting alloy for connection.

First of all, the superconducting wire for the persistent current switch was manufactured by performing hot extrusion and wiredrawing processes. A Ta sheet was wound around a NbTi alloy rod. The resulting assembly was sealed into a Cu-10 wt % Ni tube and subjected to hot extrusion and wiredrawing processes to prepare a CuNi/Ta/NbTi single-core wire. A wiredrawing process was performed on the prepared CuNi/Ta/NbTi single-core wire to produce a hexagonal wire. Approximately 2000 such wires were inserted into a CuNi alloy tube. Hot extrusion and wiredrawing processes were then performed on the resulting metal tube to produce an elongated wire having a diameter of 1.5 mm. Enamel was applied to and burned into the surface of the elongated wire for insulation purposes. The same wire rod can be obtained even when the superconducting wire is manufactured by performing, for instance, a drawbench process, an extrusion process, a different wiredrawing process, an isostatic pressing process, or a rolling process. The final diameter of the superconducting wire can be determined as desired depending on persistent current switch specifications. However, when actual operations are taken into consideration, it is preferred that the final diameter of the superconducting wire be between 0.2 mm and 3.0 mm.

Next, the superconducting wire for the persistent current switch was wound around an FRP bobbin in an noninductive manner. The high-value resistance in the PCS-OFF state of the persistent current switch was set to 10 SI. The length of the winding was 30 m. A manganin wire was wound around the winding as a heater wire. The persistent current switch was formed by impregnating the winding with resin.

The high-value resistance is determined in accordance with the excitation speed of the superconducting magnet. The winding length is determined in accordance with electrical high-value resistance per unit length of the superconducting wire. It should be noted, however, that the greater the high-value resistance, the higher the excitation speed of the superconducting magnet can be. Further, the greater the electrical high-value resistance per unit length of the wire rod, the shorter the wire rod to be used, and thus the higher the cost efficiency, stability, and cooling capability. In other words, the length of the wire rod to be used decreases with an increase in the electrical high-value resistance per unit length. However, it is ideal that the electrical high-value resistance prevailing in the PCS-OFF state of the persistent current switch be high.

Although a manganin wire was used as the heater wire, the same effect is obtained by using a nichrome wire or other common heater wire that exhibits high resistance and has a melting point higher than the heat treatment temperature for MgB₂. Further, although the heater wire was wound around the winding formed by the superconducting wire, the same effect is obtained by forming the winding with the heater wire wound around the superconducting wire, by winding a heater inside the superconducting wire, or by installing a heater in the central shaft of the bobbin, on the upper and lower part of the bobbin, or in such a manner as to cover the bobbin.

The heater to be used is not limited to those which use a heater wire. Further, the persistent current switch can also be turned on and off by using, for instance, a magnetic field instead of the heater.

The lead of the persistent current switch was secured, and its leading end was superconductively connected to the other NbTi wire. First of all, a 50 mm portion of one end of a persistent current switch superconducting wire rod was immersed in a Sn bath at 400° C. for 120 minutes, subjected to a CuNi melt treatment, and lifted out of the Sn bath. Next, a 50 mm portion of one end of a NbTi wire rod was immersed in a Sn bath at 400° C. for 20 minutes, and lifted out of the Sn bath. At this point of time, only CuNi of the superconducting wire was dissolved with Sn deposited on Ta. The NbTi filaments were not oxidized.

It is preferred that the portion to be immersed in the Sn bath be approximately 5 mm to 700 mm in length. In general, the connection length is determined in accordance with the value of the current to be supplied. However, the amount of current to be supplied drastically decreases when the portion to be immersed in the Sn bath is less than 5 mm in length. Conversely, if the portion to be immersed in the Sn bath is more than 700 mm in length, no significant effect is produced, but the size and cost of the device will be increased. The immersion in the Sn bath is conducted for a period of approximately 10 to 120 minutes at a temperature between 250° C. and 500° C. The immersion conditions are determined in accordance with the Cu content, wire rod structure, and wire rod diameter of the superconducting wire. If the immersion is conducted at an excessively high temperature or for an unduly long period of time, the electrical conduction characteristics of the superconducting wire deteriorate.

Next, the superconducting wire subjected to the melt treatment and a 55 mm portion of one end of the NbTi wire were immersed in a PbBiSn alloy bath at 400° C. for 10 minutes, and lifted out of the PbBiSn bath. At this point of time, the oxidization of NbTi wire did not progress and PbBiSn was deposited on the NbTi wire. The portion to be immersed in the PbBiSn bath is approximately 5 to 500 mm in length. It should be longer than the portion subjected to the melt treatment. The wettability of PbBiSn should be increased to ensure that Sn does not remain. It is preferred that the immersion in the PbBiSn bath be conducted for a period of approximately 10 to 60 minutes at a temperature between 150° C. and 650° C. In this case, too, the immersion conditions are determined in accordance with the wire rod structure and wire rod diameter of the superconducting wire. If the immersion is conducted at an excessively high temperature or for an unduly long period of time, the electrical conduction characteristics of the superconducting wire deteriorate.

Next, the superconducting wire on which the PbBiSn alloy was deposited was secured to the PbBiSn alloy portion (superconducting portion) of the NbTi wire by using a Cu wire, and the resulting joint was handled as a wire rod retainer. Preparing the wire rod retainer makes it possible to bring the superconducting portions into closer contact with each other, thereby improving the electrical conduction characteristics. Wire rod retention can be achieved by exercising a crimp connection method, a spot welding method, an ultrasonic welding method, a diffusion bonding method, or a solid-phase diffusion method without damaging the superconducting metal filaments. This is achievable as far as the barrier layer is made of Ta or Mo.

Finally, after the wire rod retainer was inserted into a connecting metal tube made of Cu, the connecting metal tube was filled with a PbBiSn alloy. The connecting metal tube may be made of Al, Ag, Au, or other metal having excellent cooling capability instead of Cu. The connecting metal tube is used to fill the interior of the tube with a PbBi alloy for the purpose of adapting itself to the wire rod retainer.

The present embodiment assumes that a PbBiSn alloy is used. However, a PbBi alloy, which does not contain Sn, may also be preferably used. The compounding ratio between Pb and Bi in the PbBi alloy should be within a range from Pb-35 wt % Bi to Pb-65 wt % Bi. The reason is that the influence of superconductivity of a previously used Nb barrier is no longer exerted due to the use of a Ta or Mo barrier. Thus, it is necessary to increase the critical current density of the PbBi alloy existing between NbTi filaments. The PbBi alloy can be used in a compounding ratio other than mentioned above. However, when a common connection length of approximately 100 mm is used, the resistance value is on the order of 1×10⁻¹¹Ω. Therefore, the usable persistent current coil is limited. The resistance value improves by more than 1/100 when the above compounding ratio, or more particularly, a compounding ratio of approximately Pb-50 wt % Bi (between Pb-45 wt % Bi and Pb-55 wt % Bi), is employed. Thus, the use of such a compounding ratio is effective for manufacturing an extremely stable, low-resistance connection.

Manufacturing the above-described superconducting connection makes it possible to complete a persistent current switch having both a superconducting coil portion and a superconducting connection.

### Second Embodiment

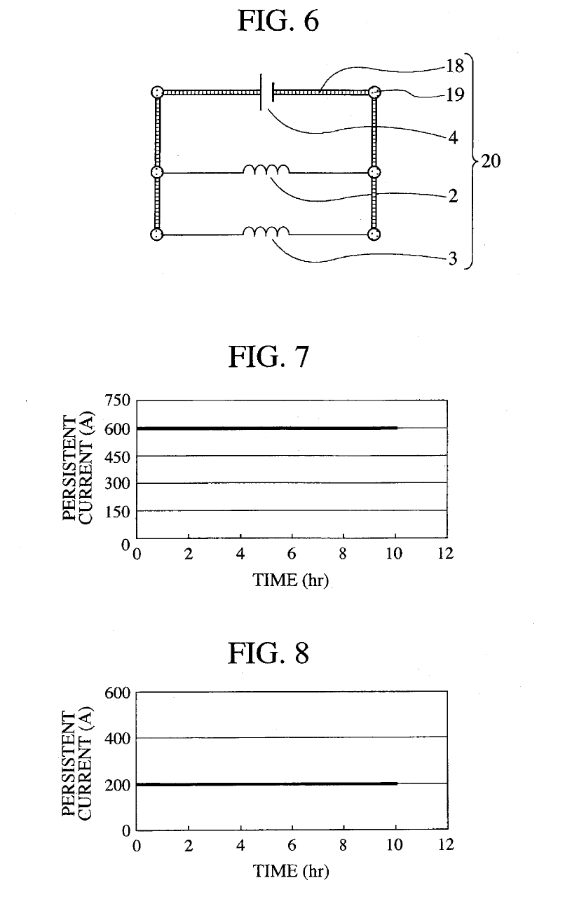

A second embodiment of the present invention will now be described. A closed-loop circuit for a persistent current test was prepared as indicated in FIG. 6. The closed-loop circuit was used to conduct a persistent current test of the persistent current switch manufactured as described in conjunction with the first embodiment. A superconducting coil 2, a persistent current switch 3, and an excitation power supply 4, which employed NbTi wires, were prepared. Superconducting connections 19 were used to connect the above-mentioned NbTi wires to connecting NbTi wires 18. Each superconducting connection was structured so that two multi-core NbTi wires were integrated and connected as shown in FIG. 5A. Ta and Mo were used as barrier materials for the NbTi wires.

The test was conducted in the sequence described below. First of all, a heater for the persistent current switch 3 was energized so that the persistent current switch switched to a normal-conducting state (9 K or higher) and turned off. The excitation power supply 4 was then used to energize and excite the superconducting coil 2. After the superconducting coil was sufficiently excited, the heater for the persistent current switch was turned off so that the persistent current switch gradually changed to the ON state. The current of the excitation power supply was then decreased to wait until the persistent current switch was sufficiently cooled. When the persistent current switch was sufficiently cooled, the persistent current operation was evaluated.

A Hall element was installed within the superconducting coil for evaluation purposes. A generated magnetic field by the superconducting coil was converted to an electrical current equivalent. The amount of temporal change in the electrical current was then measured. FIG. 7 shows the results of measurements of a persistent current circuit having a conduction current of 600 A. The measurements were made for 10 hours. The results of measurements indicate that no switching to a normal-conducting state took place during a persistent current operation, and that virtually no current attenuation occurred, and further that the high-value resistance of the entire closed circuit was not higher than 1×10⁻¹²Ω.

In addition, the same test was conducted with the conduction current varied from 100 A to 1000 A. As a result, an excellent persistent current circuit similar to the one indicated in FIG. 7 was obtained. Further, although an evaluation was conducted for a period of longer than 24 hours, no switching to a normal-conducting state took place and no significant current attenuation occurred.

Consequently, it was found that the persistent current characteristics of the persistent current switch are excellent and extremely stable when the connection is made of a superconducting wire rod having a Ta or Mo barrier according to an embodiment of the present invention.

### Third Embodiment

A third embodiment of the present invention will now be described. In the second embodiment, a superconducting coil made of a NbTi wire is used for the persistent current circuit. As regards the third embodiment, however, tests were conducted by using a superconducting coil made of a MgB₂ wire, a superconducting coil made of a Nb₃Sn wire, and a superconducting coil made of a Nb₃Al wire.

FIG. 8 shows the result of a test that was conducted by using the superconducting coil made of a MgB₂ wire. The current value used for testing purposes was 200 A. Measurements were made for 10 hours. The results of measurements indicate that no switching to a normal-conducting state took place during a persistent current operation, and that virtually no current attenuation occurred, and further that the high-value resistance of the entire closed circuit was not higher than 1×10⁻¹²Ω. In addition, the same test was conducted with the conduction current varied from 100 A to 500 A. As a result, an excellent persistent current operation could be performed without regard to the employed conduction current. Further, although an evaluation was conducted for a period of longer than 24 hours, no switching to a normal-conducting state took place and no significant current attenuation occurred.

When the Nb Sn coil and Nb₃Al coil were used, the same results were obtained over a conduction current range from 100 A to 1500 A.

The test results described above indicate that a superconducting connection can be made with very low resistance no matter what type of superconducting wire is used.

Although the present embodiment assumes that the connection is made by using a PbBi alloy as a low-melting-point superconducting alloy, the use of a MgB₂ alloy makes it possible to perform a persistent current operation at a temperature of 20 K or higher.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A persistent current switch for switching between a normal-conducting state and a superconducting state, comprising a first superconducting wire that is partly provided with a winding portion and a second superconducting wire,
wherein the first superconducting wire includes a plurality of superconducting metal filaments made of a superconducting material, a matrix made of a normal-conducting material for bundling the filaments, and a barrier layer provided on the filaments,
wherein the barrier layer being made of a metal that does not react with Sn at a temperature between 250° C. and 500° C. and does not switch to a superconducting state at 4.2 K or lower and at 0.5 T or lower, and
wherein the first and second superconducting wires are joined with a superconducting connection, and the matrix is partly removed in the superconducting connection.

2. The persistent current switch according to claim 1,
wherein the matrix is a copper-based alloy.

3. The persistent current switch according to claim 1,
wherein the matrix is an alloy made of at least CuNi, CuSn, CuZn, CuMn, CuMg, CuIn, CuCo, or CuCr.

4. The persistent current switch according to claim 1,
wherein the barrier layer is made of Ta, Mo, or a Ta- or Mo-based alloy.

5. The persistent current switch according to claim 1,
wherein the barrier layer has a thickness of 0.01 μm to 1 μm.

6. The persistent current switch according to claim 1,
wherein the matrix is solid-solved and diffused in Sn or a Sn alloy during a process for joining the first superconducting wire and the second superconducting wire.

7. The persistent current switch according to claim 1,
wherein the superconducting metal filaments are made of NbTi.

8. A method for using persistent current switch according to claim 1,
wherein the superconducting wires are used in a low magnetic field region of 2 T or lower and at a temperature of 4.2 K or lower.

9. A superconducting magnet comprising:
a superconducting coil made of a superconducting wire;
a power supply exciting the superconducting coil; and
a persistent current switch according to claim 1, which is connected to the power supply in parallel with the superconducting coil.

10. A persistent current switch comprising:
a first superconducting wire comprising NbTi;
a second superconducting wire;
a superconducting connection connecting the first and the second superconducting wires,
the first superconducting wire further comprises;
a plurality of superconducting metal filaments made of NbTi, a barrier layer made of Ta, Mo, or a Ta- or Mo-based alloy to cover each superconducting metal filament, and a CuNi alloy layer bundling the metal filaments,
wherein the first superconducting wire is connected to the second superconducting wire via a Pb alloy at the portion without the CuNi alloy layer.

11. A persistent current switch according to claim 10,
wherein the persistent current switch is placed at 4.2 K or lower and at 0.5 T or lower to switch between a normal-conducting state and a superconducting state.

12. A multi-core superconducting wire rod comprising:
a plurality of superconducting metal filaments made of a superconducting material;
a barrier layer surrounding each filament; and
a matrix made of a normal-conducting material for bundling the plurality of superconducting metal filaments;
wherein the barrier layer is made of a metal that does not react with Sn at a temperature between 250° C. and 500° C., and does not switch to a superconducting state at 4.2 K or lower and at 0.5 T or lower.

13. The superconducting wire rod according to claim 12,
wherein the matrix is made of a copper-based alloy.

14. The superconducting wire rod according to claim 12,
wherein the matrix is made of CuNi, CuSn, CuZn, CuMn, CuMg, CuIn, CuCo, or CuCr.

15. The superconducting wire rod according to claim 12,
wherein the barrier layer has a thickness of 0.01 μm to 1 μm.

16. The superconducting wire rod according to claim 12,
wherein the barrier layer is made of Ta, Mo, or a Ta- or Mo-based alloy.

17. The superconducting wire rod according to claim 12,
wherein the metal filaments are made of NbTi.

18. The superconducting wire rod according to claim 12,
wherein the matrix is solid-solved and diffused in Sn or a Sn alloy during a process for joining to another wire rod.

19. A method for using the superconducting wire rod according to claim 12,
wherein the superconducting wire rod is used in a low magnetic field region of 2 T or lower and at a temperature of 4.2 K or lower.
